(19) United States
(12) Patent Application Publication
(10) Pub. No.: US 2022/0169232 A1
(43) Pub. Date: Jun. 2, 2022

(54) MACHINE AND DRIVETRAIN ASSOCIATED WITH MACHINE

(71) Applicant: Caterpillar Paving Products Inc., Brooklyn Park, MN (US)

(72) Inventor: Brian Joe Schlenker, Shoreview, MN (US)

(73) Assignee: Caterpillar Paving Products Inc., Brooklyn Park, MN (US)

(21) Appl. No.: 17/109,250

(22) Filed: Dec. 2, 2020

(51) Int. Cl. B60W 10/103; B60K 6/543; B62D 5/06; B62D 11/00

(52) U.S. Cl. CPC B60W 10/103; B60K 6/543; E01C 23/088; B62D 11/003; B60W 2710/0644; B62D 5/063

(57) ABSTRACT

A milling machine includes an engine that generates output power and a rotor that receives the output power from the engine. The milling machine further includes a drivetrain coupled with the engine and the rotor for transmitting the output power to the rotor based on a desired output of the rotor. The drivetrain includes a transmission system operatively coupled with the engine for varying an output of the rotor without altering a load on the engine. The transmission system includes a hydrostatic arrangement operatively coupled with the engine. The transmission system also includes a mechanical arrangement coupled with the engine and the rotor arrangement. The drivetrain also includes a power transmitting arrangement coupled with the transmission system. The drivetrain further includes a gearbox coupled to the power transmitting arrangement and the rotor, such that the power transmitting arrangement is disposed between the transmission system and the gearbox.

### TECHNICAL FIELD

The present disclosure relates to a machine, and more specifically, to a drivetrain associated with a rotor of the machine.

### BACKGROUND

Machines, such as cold planers, road reclaimers, pavement profilers, roadway planers, rotary mixers, and the like, are designed for performing tasks like scarifying, removing, mixing, or reclaiming material from ground surfaces. These machines typically have a rotor that may be mechanically or hydraulically driven to accomplish the above mentioned tasks. The rotor receives operating power from an engine of the machine. Typically, a rotational speed of the rotor may have to be manually or automatically adjusted based on a nature of the task being performed.

Currently, drivetrains of such machines rely on a speed of the engine or a multi-speed gearbox to achieve different rotor speeds. Further, a design of such drivetrains may not allow variation in rotor speeds when the engine is operating under load. More particularly, the speed of the engine may have to be reduced to change the rotor speed. Accordingly, an operator of the machine may have to stop the machine and reduce the engine speed for changing the rotor speed. This technique may cause an undesirable reduction in machine productivity.

U.S. Pat. No. 9,975,538 describes a controller-implemented method of controlling a machine having a rotor coupled to an engine through a variable transmission. The controller-implemented method includes receiving a desired rotor speed, determining an engine load of the engine, adjusting an engine speed of the engine based on the engine load and one or more predefined efficiency points, and adjusting a gear ratio of the variable transmission based on the engine speed and the desired rotor speed. Further, the variable transmission allows changes in rotor speed irrespective of changes in the engine speed.

### SUMMARY OF THE DISCLOSURE

In one aspect of the present disclosure, a milling machine is provided. The milling machine includes an engine that generates output power. The milling machine also includes a rotor that receives the output power from the engine. The milling machine further includes a drivetrain coupled with the engine and the rotor for transmitting the output power to the rotor based on a desired output of the rotor. The drivetrain includes a transmission system operatively coupled with the engine for varying an output of the rotor without altering a load on the engine. The transmission system includes a hydrostatic arrangement operatively coupled with the engine. The transmission system also includes a mechanical arrangement coupled with the engine and the rotor arrangement. The drivetrain also includes a power transmitting arrangement coupled with the transmission system. The drivetrain further includes a gearbox coupled to the power transmitting arrangement and the rotor, such that the power transmitting arrangement is disposed between the transmission system and the gearbox.

In another aspect of the present disclosure, a drivetrain for operating a rotor of a machine at a desired output is provided. The machine includes an engine that generates output power. The drivetrain includes a transmission system operatively coupled with the engine for varying an output of the rotor without altering a load on the engine, wherein the transmission system receives the output power from the engine. The transmission system includes a hydrostatic arrangement operatively coupled with the engine. The transmission system also includes a mechanical arrangement coupled with the engine and the rotor arrangement. The drivetrain also includes a power transmitting arrangement coupled with the transmission system. The drivetrain further includes a gearbox coupled to the power transmitting arrangement and the rotor, such that the power transmitting arrangement is disposed between the transmission system and the gearbox.

Other features and aspects of this disclosure will be apparent from the following description and the accompanying drawings.

### BRIEF DESCRIPTION OF THE DRAWINGS

FIG. 1 is a side view of an exemplary milling machine;

FIG. 2 is a block diagram illustrating an engine and a transmission system associated with the milling machine of FIG. 1, in accordance with the present disclosure;

FIG. 3 is a line diagram illustrating the transmission system of FIG. 2;

FIG. 4 illustrates a block diagram of a drivetrain; and

FIG. 5 is a line diagram illustrating the drivetrain and a power disengagement device associated with the drivetrain.

### DETAILED DESCRIPTION

Wherever possible, the same reference numbers will be used throughout the drawings to refer to the same or the like parts. Wherever possible, corresponding or similar reference numbers will be used throughout the drawings to refer to the same or corresponding parts.

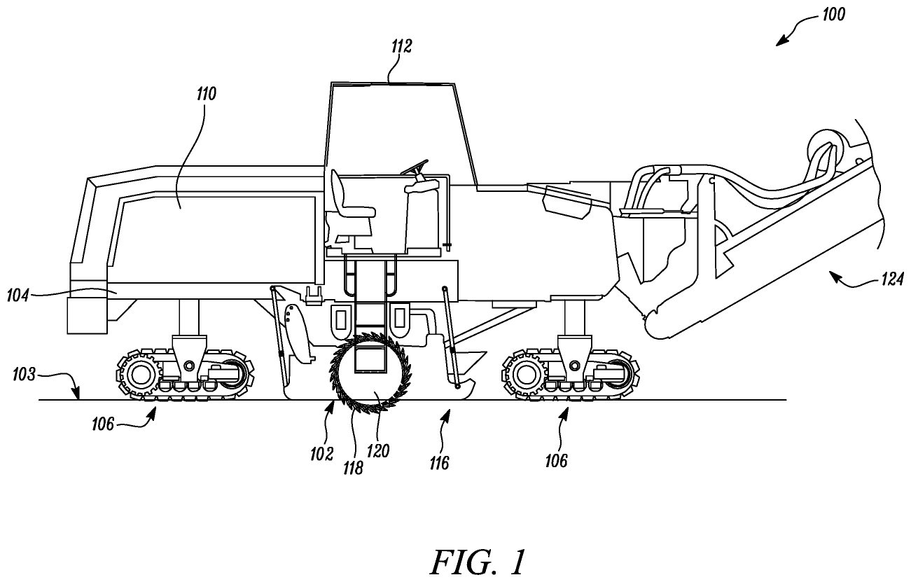

FIG. 1 illustrates an exemplary machine 100. In the illustrated example, the machine 100 is a milling machine. The machine 100 may be hereinafter interchangeably referred to as the milling machine 100. The machine 100 is embodied as a cold planer herein. Although shown as a cold planer, it may be understood that the machine 100 may alternatively include road reclaimers, pavement profilers, roadway planers, rotary mixers, or any other suitable machine having a rotor 102 or a milling device that may be used to scarify, remove, mix, or reclaim material from a ground surface 103. In an example, the ground surface 103 may include bituminous or concrete roadways or other such surfaces. The machine 100 includes a frame 104. The machine 100 also includes a pair of track assemblies 106 supported by the frame 104 that propel the machine 100 on the ground surface 103.

The machine 100 includes an engine 108 that generates output power. The engine 108 is received within an engine compartment 110. The engine 108 may be an internal combustion engine. The engine 108 may include a gasoline engine, a diesel engine, a natural gas engine, and the like. The engine 108 may supply the output power to various machine components for operation thereof. The engine 108 is operatively coupled to the track assemblies 106 via a machine transmission system (not shown) for providing operating power to the track assemblies 106.

The machine 100 also includes an operator cabin 112. An operator of the machine 100 may sit or stand in the operator cabin 112 for performing one or more machine operations. The operator cabin 112 includes a user interface (not shown). The user interface may include input and output devices for controlling one or more machine components such as the engine 108, the machine transmission system, a drivetrain 114, and the like.

The machine 100 further includes the rotor 102 that receives the output power from the engine 108. The rotor 102 is disposed within a rotor chamber 116. The rotor 102 is disposed in the rotor chamber 116 such that the rotor 102 is exposed to the ground surface 103. The rotor 102 may include a number of cutting assemblies 118 mounted on a drum 120 of the rotor 102. The cutting assemblies 118 contact with the ground surface 103 during a work operation.

Further, a speed of the rotor 102 can be adjusted based on a desired output of the rotor 102. The desired output of the rotor 102 may include a desired rotor speed at which the rotor 102 needs to be operated for accomplishing various work operations. The desired output of the rotor 102 may depend on a number of factors associated with a particular work operation or machine operating parameters. The desired output of the rotor 102 is based on one of a desired depth of cut, a travel speed of the machine 100, a hardness of material being cut, a desired material size, and a density of the material being cut. It should be noted that the factors associated with the work operation and/or the machine operating parameters mentioned above are exemplary in nature and the desired output of the rotor 102 may depend on any other factors, as per application requirements.

Further, the machine 100 may include a number of hydraulic cylinders (not shown) associated with the rotor 102. For example, a height of the rotor 102 with respect to the ground surface 103 may be adjusted in order adjust the depth of cut, based on extension or retraction of one or more hydraulic cylinders. The machine 100 further includes a conveyor assembly 124 which delivers material removed by the rotor 102 into a receptacle (not shown). More particularly, the conveyor assembly 124 transports materials from the rotor chamber 116 to the receptacle.

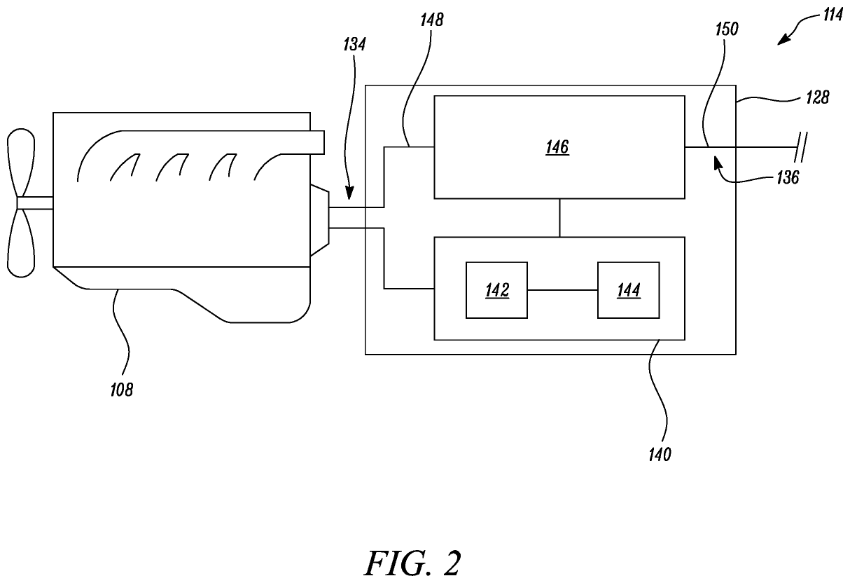

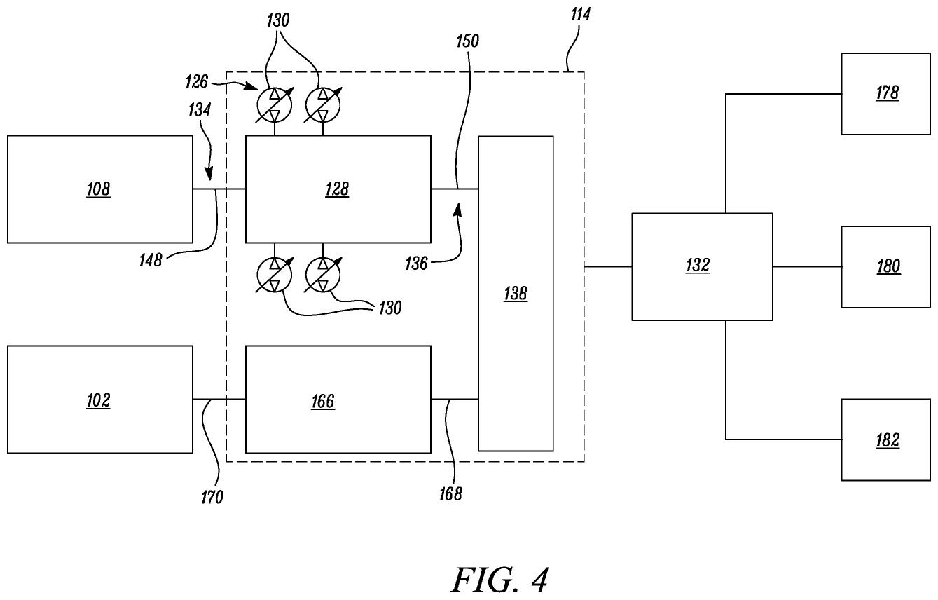

The machine 100 includes a power take-off system 126 (shown in FIG. 4) disposed between the engine 108 and a transmission system 128 (shown in FIGS. 2 and 4). The power take-off system 126 receives the output power from the engine 108. The power take-off system 126 includes one or more hydraulic pumps 130 (shown in FIG. 4). As illustrated, the power take-off system 126 includes four hydraulic pumps 130. The power take-off system 126 directs some portion of the output power from the engine 108 to the hydraulic pumps 130. The hydraulic pumps 130 may in turn provide operating power to a motor (not shown) of the conveyor assembly 124, the hydraulic cylinders for extension/retraction of the rotor 102, the machine transmission system, and/or other machine components, without limiting the scope of the present disclosure.

Further, the power take-off system 126 directs a portion of the output power from the engine 108 to the drivetrain 114 of the machine 100 for operating the rotor 102. In an example, the power take-off system 126 may include a splined shaft to supply the output power of the engine 108 to the drivetrain 114. As shown in FIG. 2, the machine 100 includes the drivetrain 114 coupled with the engine 108 and the rotor 102 (see FIGS. 1 and 4) for transmitting the output power to the rotor 102 based on the desired output of the rotor 102. In an example, the drivetrain 114 may transmit or restrict power flow from the engine 108 towards the rotor 102 in an operating condition of the engine 108. In one example, one or more components of the drivetrain 114 may be controlled based on inputs from the operator. Such inputs may be provided via the user interface present in the operator cabin 112 (see FIG. 1). In another example, the components of the drivetrain 114 may be controlled by a controller 132 based on the desired output of the rotor 102. The controller 132 associated with the machine 100 will be explained later in this section.

The drivetrain 114 includes the transmission system 128 operatively coupled with the engine 108 for varying the output of the rotor 102 without altering a load on the engine 108. The transmission system 128 defines an input end 134 operatively coupled to the engine 108 for receiving the output power therefrom and an output end 136. In an example, the input end 134 of the transmission system 128 is coupled with the power take-off system 126 (see FIG. 4). Further, the output end 136 is coupled to a power transmitting arrangement 138 (see FIG. 4) of the drivetrain 114.

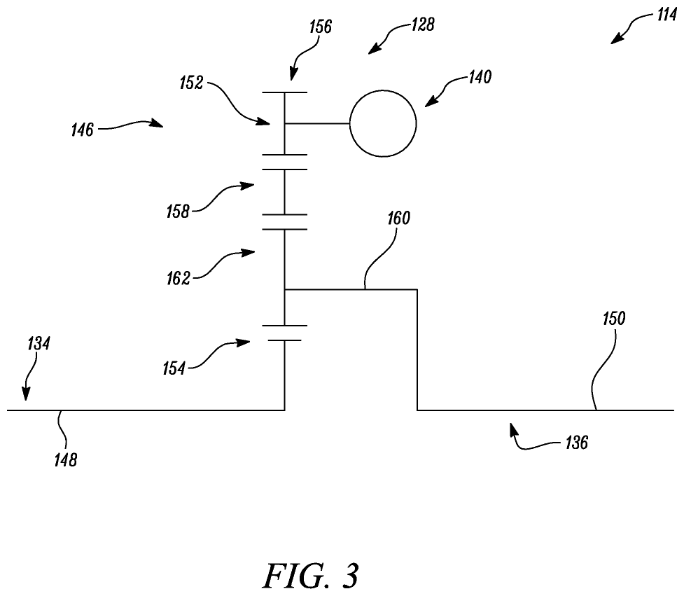

In an example, as shown in FIGS. 2 and 3, the transmission system 128 includes a Continuously Variable Transmission (CVT) system. The transmission system 128 provides different drive ratios and continuously adjust the drive ratio between the input end 134 and the output end 136 of the transmission system 128. The transmission system 128 includes a hydrostatic arrangement 140 operatively coupled with the engine 108 (see FIG. 2). The engine 108 supplies a portion of the output power to the hydrostatic arrangement 140. The hydrostatic arrangement 140 includes a hydraulic pump 142 (shown in FIG. 2) and a hydraulic motor 144 (shown in FIG. 2). The hydraulic pump 142 may be a reversible, variable displacement type pump driven by the engine 108 through a suitable drive connection. The hydrostatic arrangement 140 may also include one or more fluid lines (not shown) for hydromechanically coupling the engine 108 with a mechanical arrangement 146.

Further, the transmission system 128 includes the mechanical arrangement 146 coupled with the engine 108 and the hydrostatic arrangement 140. The engine 108 supplies a portion of the output power to the mechanical arrangement 146. The mechanical arrangement 146 includes a first input shaft 148 at the input end 134 and a first output shaft 150 at the output end 136. The first input shaft 148 is coupled with the power take-off system 126 (see FIG. 4) and the first output shaft 150 is coupled with the power transmitting arrangement 138 (see FIG. 4).

Referring to FIG. 3, the mechanical arrangement 146 includes one or more planetary arrangements 152. In some examples, the mechanical arrangement 146 may include a spur gear arrangement, a helical arrangement, a bevel gear arrangement, and the like, without any limitations. In the illustrated example, the planetary arrangement 152 incudes a sun gear 154 operatively coupled with the engine 108 (see FIGS. 2 and 4). An output shaft of the engine 108 may be operatively coupled to the first input shaft 148 on which the sun gear 154 is mounted for driving the sun gear 154. It should be noted that the mechanical arrangement 146 may include a suitable coupling means (not shown) for operatively coupling the power take-off system 126 (see FIG. 4) with the sun gear 154. Such coupling means may include an arrangement of pulleys, belts, roller chains, gear drives, and the like.

The planetary arrangement 152 includes an input gear 156. The input gear 156 is driven by the hydrostatic arrangement 140. Further, the planetary arrangement 152 includes a ring gear 158 operatively coupled with the hydrostatic arrangement 140. The ring gear 158 meshes with the input gear 156. The hydrostatic arrangement 140 may hydromechanically couple the engine 108 with the ring gear 158. Specifically, the hydraulic pump 142 provides input to the hydraulic motor 144 through the fluid lines. Further, the hydraulic motor 144 mechanically drives the ring gear 158, via the input gear 156. In various examples, the hydrostatic arrangement 140 may drive the ring gear 158 at various speeds, as per requirements.

The planetary arrangement 152 further includes a carrier 160 operatively coupled with the power transmitting arrangement 138. The carrier 160 is mounted on the first output shaft 150. The carrier 160 is coupled with a planet gear 162. The planet gear 162 meshes with the ring gear 158 and the sun gear 154. The combination of the mechanical arrangement 146 and the hydrostatic arrangement 140 may be used to achieve a desired output speed at the carrier 160 which is coupled to the power transmitting arrangement 138. Specifically, any suitable speed can be achieved and maintained at the carrier 160 by manipulation of a speed of the sun gear 154 and/or a speed of the ring gear 158. The mechanical arrangement 146 and the hydrostatic arrangement 140 may be operated to continuously adjust the drive ratio, for instance, between the input end 134 and the output end 136.

As shown in FIG. 4, the drivetrain 114 includes the power transmitting arrangement 138 coupled to the transmission system 128. The power transmitting arrangement 138 is coupled to the output end 136 of the transmission system 128. Specifically, the first output shaft 150 of the mechanical arrangement 146 is coupled with the power transmitting arrangement 138. The power transmitting arrangement 138 operatively couples the transmission system 128 with a gearbox 166 of the drivetrain 114 to direct an output of the transmission system 128 towards the gearbox 166. The power transmitting arrangement 138 includes one or more of a pulley arrangement, a belt arrangement, a roller chain arrangement, and a gear drive. It should be noted that the present disclosure is not limited to a type of the power transmitting arrangement 138.

The drivetrain 114 also includes the gearbox 166 coupled to the power transmitting arrangement 138 and the rotor 102. The power transmitting arrangement 138 is disposed between the transmission system 128 and the gearbox 166. The gearbox 166 is coupled to the power transmitting arrangement 138 and the rotor 102 for transmitting the output power to the rotor 102. The gearbox 166 receives the output power from the engine 108 through the transmission system 128 and the power transmitting arrangement 138. In an example, the gearbox 166 is a single speed gearbox. In other examples, the gearbox 166 may be embodied as a multi-speed gearbox. The gearbox 166 may provide a number of drive ratios for operation of the rotor 102. The gearbox 166 includes a second input shaft 168 and a second output shaft 170. The second input shaft 168 of the gearbox 166 is coupled to the power transmitting arrangement 138. The second output shaft 170 of the gearbox 166 is coupled to the rotor 102. The gearbox 166 may include a number of gears arranged to provide different drive ratios. In an example, the gearbox 166 may include one or more planetary gearsets. In some examples, the gearbox 166 may include a spur gear arrangement, a helical arrangement, a bevel gear arrangement, and the like, without any limitations.

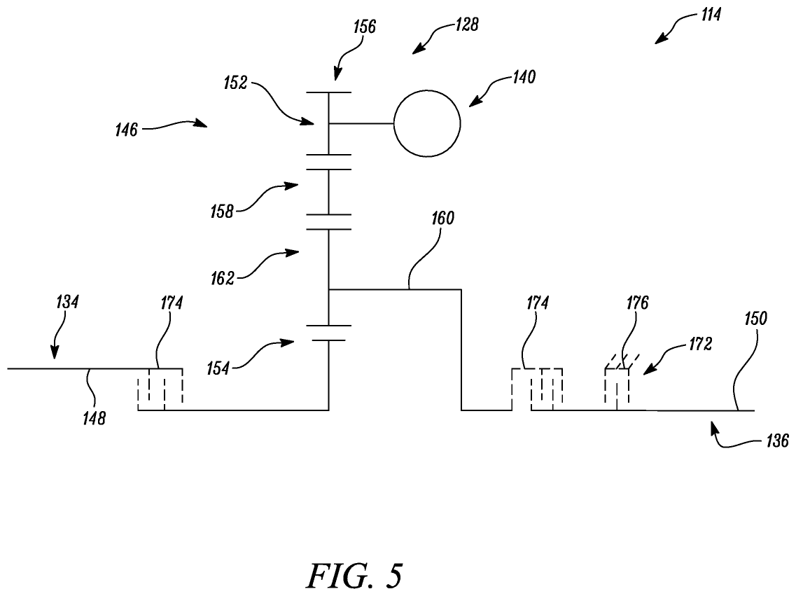

As shown in FIG. 5, the drivetrain 114 includes a power disengagement device 172 for selectively disengaging the engine 108 (see FIG. 4) from the rotor 102 (see FIG. 4) in the operating condition of the engine 108. The power disengagement device 172 may be engaged to allow power flow from the engine 108 towards the rotor 102 whereas the power disengagement device 172 may be disengaged to prevent power flow from the engine 108 towards the rotor 102. The power disengagement device 172 may include a clutch 174 or a brake assembly 176. Various exemplary locations of the clutch 174 and the brake assembly 176 are illustrated using hidden lines in the accompanying figure.

In one example, the drivetrain 114 includes the clutch 174 for selectively disengaging the engine from the rotor 102. In an example, the clutch 174 may be hydraulically operated. The clutch 174 may include one or more of a friction clutch, a single plate clutch, a multi plate clutch, a cone clutch, a centrifugal clutch, or any other type of clutch that can be used for engaging or disengaging two components. The clutch 174 is disposed on the input end 134 or the output end 136 of the transmission system 128. More particularly, the clutch 174 may be disposed at two locations in the drivetrain 114 as illustrated.

In one example, the clutch 174 may be disposed between the power take-off system 126 (see FIG. 4) and the transmission system 128. In such an example, the clutch 174 may selectively disengage the engine 108 and the drivetrain 114. Specifically, the clutch 174 selectively disengages the engine 108 and the transmission system 128. In an engaged position, the clutch 174 allows transmission of the output power from the engine 108 to the transmission system 128. In a disengaged position, the clutch 174 prevents power flow from the engine 108 towards the transmission system 128.

In another example, the clutch 174 may be disposed between the transmission system 128 and the power transmitting arrangement 138 (see FIG. 4). In such an example, the clutch 174 may selectively disengage the transmission system 128 and the power transmitting arrangement 138. In an engaged position, the clutch 174 allows transmission of the output power from the transmission system 128 towards the power transmitting arrangement 138. In a disengaged position, the clutch 174 prevents power flow from the transmission system 128 towards the power transmitting arrangement 138.

In yet another example, the drivetrain 114 includes the brake assembly 176 for selectively disengaging the engine 108 from the rotor 102. In this example, the brake assembly 176 is disposed between the transmission system 128 and the power transmitting arrangement 138. Further, the brake assembly 176 may selectively disengage the transmission system 128 and the power transmitting arrangement 138. In a disengaged position, the brake assembly 176 allows transmission of the output power from the transmission system 128 towards the power transmitting arrangement 138. In an engaged position, the brake assembly 176 prevents power flow from the transmission system 128 towards the power transmitting arrangement 138.

In an example, the brake assembly 176 may be hydraulically operated. However, other techniques may be used for engaging/disengaging the brake assembly 176. The brake assembly 176 may include one or more of a disc brake, a drum brake, or any other type of brake assembly that disengages the transmission system 128 and the power transmitting arrangement 138. It should be noted that, in some examples, the drivetrain 114 may eliminate the power disengagement device 172. In such examples, the transmission system 128 can be controlled in a manner such that the rotor speed is minimal or the rotor speed is approximately equal to zero.

Referring now to FIG. 4, the drivetrain 114 is controlled based on the desired output of the rotor 102. In some examples, the speed of the rotor 102 can be controlled based on the desired output of the rotor 102. Further, the desired output of the rotor 102 may be based on the desired depth of cut, the travel speed of the machine 100, the hardness of material being cut, the desired material size, or the density of the material being cut. Accordingly, the speed of the rotor 102 may be controlled to achieve a desired outcome. For this purpose, the machine 100 includes the controller 132. In an example, the controller 132 may directly control one or more components of the drivetrain 114 based on the desired output of the rotor 102. For example, the controller 132 may change the drive ratios of the transmission system 128 or the gearbox 166, or control the power transmitting arrangement 138, based on the desired output of the rotor 102. Further, the controller 132 may also control the power disengagement device 172 (see FIG. 5) for transmitting or restricting power flow towards the rotor 102.

The controller 132 may embody a stand-alone device, or the controller 132 may embody an Electronic Control Unit (ECU) or an Engine Control Module (ECM) that may be present onboard the machine 100. The controller 132 may include a Central Processing Unit (CPU), a microprocessor, a microcontroller, a control unit, or another type of processing component capable of being programmed to perform certain functions/operations.

Moreover, the machine 100 includes a number of sensors 178, 180, 182 that assist in controlling the desired output of the rotor 102. In an example, the machine 100 may include the first sensor 178 to detect the travel speed of the machine 100. In another example, the machine 100 may include the second sensor 180 that detects the speed of the engine 108. In yet another example, the machine 100 may include the third sensor 18 that detects the speed of the rotor 102. The sensors 178, 180, 182 may include speed sensors that are generally known in the art that may allow speed detection, such as hall effect sensors, encoders, and the like. Additionally, the machine 100 may include other sensors for detecting other machine parameters that may assist in controlling the desired output of the rotor 102. Further, the controller 132 is communicably coupled to the sensors 178, 180, 182 and receives input signals from the sensors 178, 180, 182. Moreover, the controller 132 controls one or more components of the drivetrain 114 based on the input signals to achieve the desired output of the rotor 102.

### INDUSTRIAL APPLICABILITY

The present disclosure relates to the drivetrain 114 associated with the machine 100. The drivetrain 114 allows the operator to change the speed of the rotor 102 while the engine 108 is in the operating condition. Thus, a requirement of halting or reducing the speed of the machine 100 and/or the engine 108 is eliminated. The transmission system 128 includes the CVT system herein which provides continuously adjustable drive ratios and also allows shifting of the drive ratios without altering the load on the engine 108. Further, a combination of the transmission system 128 and the gearbox 166 provides a wider range of rotor speeds without stopping machine operation.

The drivetrain 114 described herein includes a simple design. Further, the drivetrain 114 includes the power disengagement device 172 which may transmit or restrict power flow from the engine 108 to the rotor 102. Thus, the rotor 102 may be stopped as and when desired using the power disengagement device 172, even when the engine 108 is operating under load. Further, the drivetrain 114 along with the controller 132 and the sensors 178, 180, 182 allow optimization in rotor speeds based on the desired output of the rotor 102. Moreover, the present disclosure may allow dynamic and precise control of the rotor 102.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof

What is claimed is:

1. A milling machine comprising:
an engine that generates output power;
a rotor that receives the output power from the engine; and
a drivetrain coupled with the engine and the rotor for transmitting the output power to the rotor based on a desired output of the rotor, the drivetrain including:
a transmission system operatively coupled with the engine for varying an output of the rotor without altering a load on the engine, the transmission system including:
a hydrostatic arrangement operatively coupled with the engine; and
a mechanical arrangement coupled with the engine and the hydrostatic arrangement;
a power transmitting arrangement coupled with the transmission system; and
a gearbox coupled to the power transmitting arrangement and the rotor, such that the power transmitting arrangement is disposed between the transmission system and the gearbox.

2. The milling machine of claim 1, wherein the hydrostatic arrangement includes a hydraulic pump and a hydraulic motor.

3. The milling machine of claim 1, wherein the mechanical arrangement includes at least one planetary arrangement that includes:
a sun gear operatively coupled with the engine;
a ring gear operatively coupled with the hydrostatic arrangement; and
a carrier operatively coupled with the power transmitting arrangement.

4. The milling machine of claim 1, wherein the power transmitting arrangement includes at least one of a pulley arrangement, a belt arrangement, a roller chain arrangement, and a gear drive.

5. The milling machine of claim 1, wherein the drivetrain includes a clutch for selectively disengaging the engine from the rotor, and wherein the clutch is disposed on at least one of an input end and an output end of the transmission system.

6. The milling machine of claim 1, wherein the drivetrain includes a brake assembly for selectively disengaging the engine from the rotor, and wherein the brake assembly is disposed between the transmission system and the power transmitting arrangement.

7. The milling machine of claim 1 further comprising a power take-off system disposed between the engine and the transmission system, wherein the power take-off system receives the output power from the engine.

8. The milling machine of claim 7, wherein the power take-off system includes at least one hydraulic pump.

9. The milling machine of claim 1, wherein the drivetrain is controlled based on the desired output of the rotor.

10. The milling machine of claim 9, wherein the desired output of the rotor is based on at least one of a desired depth of cut, a travel speed of the milling machine, a hardness of material being cut, a desired material size, and a density of the material being cut.

11. A drivetrain for operating a rotor of a machine at a desired output, wherein the machine includes an engine that generates output power, the drivetrain comprising:
a transmission system operatively coupled with the engine for varying an output of the rotor without altering a load on the engine, wherein the transmission system receives the output power from the engine, the transmission system including:
a hydrostatic arrangement operatively coupled with the engine; and
a mechanical arrangement coupled with the engine and the hydrostatic arrangement;
a power transmitting arrangement coupled with the transmission system; and
a gearbox coupled to the power transmitting arrangement and the rotor, such that the power transmitting arrangement is disposed between the transmission system and the gearbox.

12. The drivetrain of claim 11, wherein the hydrostatic arrangement includes a hydraulic pump and a hydraulic motor.

13. The drivetrain of claim 11, wherein the mechanical arrangement includes at least one planetary arrangement that includes:
a sun gear operatively coupled with the engine;
a ring gear operatively coupled with the hydrostatic arrangement; and
a carrier operatively coupled with the power transmitting arrangement.

14. The drivetrain of claim 11, wherein the power transmitting arrangement includes at least one of a pulley arrangement, a belt arrangement, a roller chain arrangement, and a gear drive.

15. The drivetrain of claim 11 further including a clutch for selectively disengaging the engine from the rotor, and wherein the clutch is disposed on at least one of an input end and an output end of the transmission system.

16. The drivetrain of claim 11 further including a brake assembly for selectively disengaging the engine from the rotor, and wherein the brake assembly is disposed between the transmission system and the power transmitting arrangement.

17. The drivetrain of claim 11 further comprising a power take-off system disposed between the engine and the transmission system, wherein the power take-off system receives the output power from the engine.

18. The drivetrain of claim 17, wherein the power take-off system includes at least one hydraulic pump.

19. The drivetrain of claim 11, wherein the drivetrain is controlled based on the desired output of the rotor.

20. The drivetrain of claim 19, wherein the desired output of the rotor is based on at least one of a desired depth of cut, a travel speed of the machine, a hardness of material being cut, a desired material size, and a density of the material being cut.
